(19) United States
(12) Patent Application Publication
(10) Pub. No.: US 2003/0122520 A1
(43) Pub. Date: Jul. 3, 2003

(54) Stepping motor controlling device and method thereof

(75) Inventors: Chun-Jen Chen, Taichung (TW); Shih-Huang Chen, Hsin-Chu (TW)

Correspondence Address: LOWE HAUPTMAN GILMAN & BERNER, LLP, Suite 310, 1700 Diagonal Road, Alexandria, VA, 22314, US

(73) Assignee: Umax Data Systems Inc.

(21) Appl. No.: 10/029,872

(22) Filed: Dec. 31, 2001

(51) Int. Cl. H02P 8/00

(52) U.S. Cl. 318/696

(57) ABSTRACT

A stepping motor controlling device and method are provided. The controlling device comprises a control circuit and a serial in-parallel out interface. The control circuit includes a motor controlling signal generator and a parallel in-serial out interface. The motor controlling signal generator generates a set of controlling signals in parallel and via the parallel in-serial out interface sends the set of controlling signals to the serial in-parallel out interface. The serial in-parallel out interface receives the set of control signals in sequence and then outputs them in parallel to a stepping motor driver for driving a stepping motor to a predetermined step.

### BACKGROUND OF THE INVENTION

1. Field of the Invention

The present invention relates to the control of a motor, especially in relation to the control of a stepping motor used in an image scanner.

2. Description of the Prior Art

In traditional scanners or other kinds of image processing systems like printers, a stepping motor is used as the driving apparatus for moving and position control of the scanning head. The step-by-step driving characteristic of the stepping motor is achieved by the design and wiring of coils on the rotor or the stators.

FIG. 1 depicts the coils of a typical prior art stepping motor which is designed to rotate in 60-degree steps. The stepping motor has a rotor that is driven by two coils. The stepping motor can advance or retreat in 60 degree increments. In order to cause the stepping motor to move through the steps, potentials are applied to coils A and B. Coil A has two terminals, A₁ and A₂. Likewise coil B has two terminals, B₁ and B₂. By applying potentials of positive voltage, negative voltage and zero voltage across coils A and B, the stepping motor is made to step through its range of motion. FIG. 2 depicts a symbol for the stepping motor showing terminals A₁, A₂, B₁ and B₂ on the body of the stepping motor.

FIG. 3 is a table showing the operation and required potentials to be applied to cots A and B to control the stepping motor of FIG. 2. For each position, or step, the coils must receive certain potentials. For this example, the stepping motor moves in 60-degree increments, and therefore there are 6 possible positions, each 60 degrees from its neighbors. Each position is labeled with a state number from state 0 to state 5. The stepping motor can move from a given state by continuing in the same direction another 60 degrees, or by retreating to the previous state by moving backwards 60 degrees. As an example, consider a single step motion. To move from the zero position to the 60 degree position, coils A and B must go from state 0; where both have positive potentials applied as indicated by the “1” in the A and B fields of state 0, to state 1, where the coil A has a positive potential applied and the B coil has a zero potential applied, as indicated by the 1 in the A field for state 1, and the zero in the B field in state 1.

Because the coils may have potentials of +1, 0 and −1 applied, the stepping motor control circuitry must control four terminals, two for each coil. For example, in state 2, the B coil receives a potential of −1 as indicated by the −1 in the B field for state 2. This means that the B₁ terminal has a 0 value, and the B₂ terminal as +1 value, as seen from the table for B₁ and B₂ in state 2 in the figure. In other words, a negative potential is applied in this state. In contrast, consider state 0, where a positive potential is to be applied to coil B. This means that a +1 potential is applied to terminal B₁, and a zero potential is applied to terminal B₂. The stepping motor moves a predetermined stepped angle in accordance with the inputs of +1 value potential and 0 value potential respectively applied to the four terminals A₁, A₂, B₁ and B₂ of the coils A and B.

FIG. 4 illustrates a functional block diagram of a prior driving apparatus for an image scanner. The driving apparatus comprises a control circuit 40, a stepping motor driver 42 and a stepping motor 44. The control circuit 40 can be realized by an application specific integrated circuit (ASIC) that usually includes a digital motor driving signal generator 402. The digital motor driving signal generator 402 generates a set of digital signals including high logic level “1” and low logic level “0”, and then outputs the set of digital signals in parallel to the stepping motor driver 42. The stepping motor driver 42 is responsive to the set of digital signals for applying a corresponding potential, i.e. positive potential or zero potential, via an output pin 43, to the respective terminals of the coils of the stepping motor 44. Thereby the stepping motor 44 is driven to a predetermined stepped angle.

In this prior driving apparatus, the output of each set of digital signals including +1 value and 0 value is controlled by a control pin of the control circuit 40 connected to the stepping motor driver 42. The control circuit 40, for example, an application specific integrated circuit, needs to provide additional control pins for outputting a set of control signals to the stepping motor driver 42. These control pins occupy large areas of the control circuit 40. Accordingly, it is an intention to provide an improved control device for a stepping motor, which can reduce control pin numbers of a control circuit for the stepping motor.

### SUMMARY OF THE INVENTION

It is one objective of the present invention to provide a stepping motor controlling device which utilizes a parallel in-serial out interface established in a control circuit to control output of a set of control signals in sequence for a stepping motor from the control circuit. Thereby, the control pin number of the control circuit for the stepping motor can be reduced and the volume of the control circuit can be shrunk.

It is another objective of the present invention to provide a stepping motor controlling device which can reduce the control pin number of the control circuit for the stepping motor and thus the volume of the control circuit can be shrunk. Therefore, it is sufficient for the control circuit to use smaller cables or connectors for controlling additional external devices, such as, automatic document feeder (ADF) and upper transparence adapter. The manufacturing cost of the controlling device can also be reduced.

In order to achieve the above objectives of this invention, the present invention provides a stepping motor controlling device and method thereof. The controlling device comprises a control circuit and a serial in-parallel out interface. The control circuit includes a motor controlling signal generator and a parallel in-serial out interface. The motor controlling signal generator generates a set of controlling signals in parallel and via the parallel in-serial out interface sends the set of controlling signals to the serial in-parallel out interface. The serial in-parallel out interface receives the set of control signals in sequence and then outputs them in parallel to a stepping motor driver for driving a stepping motor to move a predetermined step.

### BRIEF DESCRIPTION OF THE DRAWINGS

The present invention can be best understood through the following description and accompanying drawings, wherein:

FIG. 1 depicts the coils for an exemplary stepping motor;

FIG. 2 depicts a symbol for the stepping motor of FIG. 1, showing the four control terminals that must be driven to control the action of the stepping motor;

FIG. 3 depicts a transition table for stepping motor control circuitry of the prior art, showing the values used at the control terminals of FIG. 2;

FIG. 4 is a functional block diagram of a prior driving apparatus of an image scanner;

FIG. 5 is a functional block diagram of a driving apparatus according to the present invention;

FIG. 6A is a schematic diagram of a parallel in-serial out type register used in the present invention; and

FIG. 6B is a schematic diagram of a serial in-parallel out type register used in the present invention.

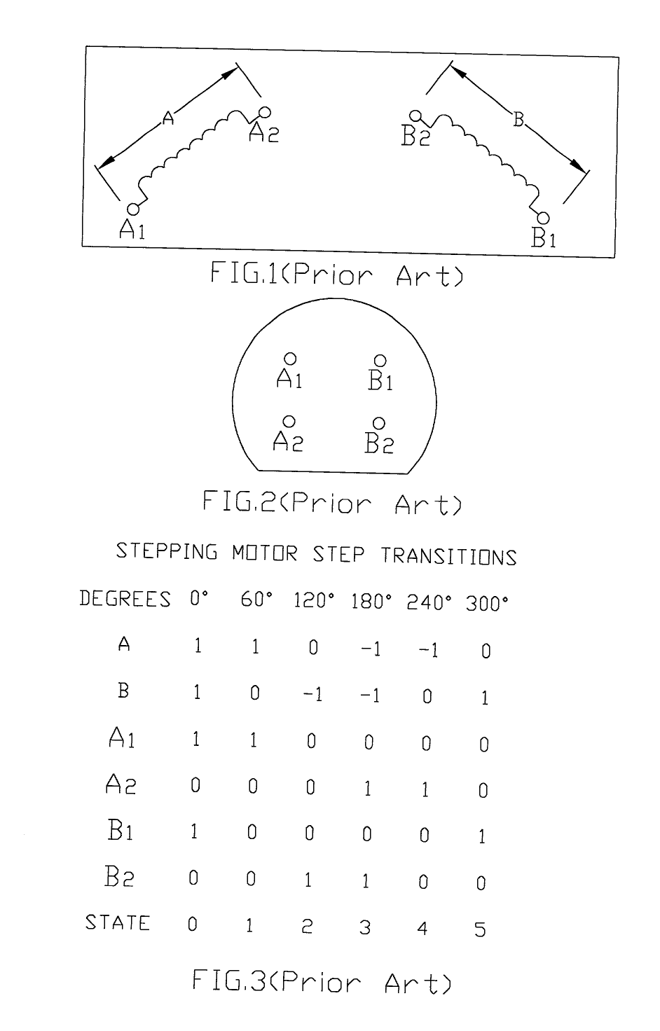

### DESCRIPTION OF THE PREFERRED EMBODIMENT

The present invention provides a stepping motor controlling device, especially used in an image scanner. The stepping motor is configured to move the scanning head of the image scanner. The present device is used to provide a set of control signals to a stepping motor driver for driving the stepping motor to a predetermined step. The operation of the stepping motor of this invention is the same with the stepping motor previously described above in the background, and depicted in the prior art drawings FIGS. 1 and 2.

FIG. 5 is a functional block diagram of a driving apparatus for an image scanner according to the present invention. The driving apparatus comprises a motor controlling part 51 and a motor device part 53. The motor controlling part 51 includes a control circuit 50. The motor device part 53 includes a serial in-parallel out interface 52, a stepping motor driver 54 and a stepping motor 56. The control circuit 50 further includes a motor controlling signal generator 502 and a parallel in-serial out interface 504. The control circuit 50 can be realized by an application specific integrated circuit (ASIC). The motor controlling signal generator 502 can be a digital motor driving signal generator or a digital motor driving signal generating circuit. The motor controlling signal generator 502 generates a set of digital signals in parallel to the parallel in-serial out interface 504. The parallel in-serial out interface 504 send the set of digital signals in sequence to the serial in-parallel out interface 52. More specifically, the motor controlling signal generator 502 generates a set of digital signals including high logic level “1” and low logic level “0” and sends them in parallel to the parallel in-serial out interface 504. Thereby, the parallel in-serial out interface 504 outputs the set of digital signals in sequence to the serial in-parallel out interface 52. This means that each set of digital signals via the parallel in-serial out interface 504 is sequentially sent to the serial in-parallel out interface 52 upon a clock transition.

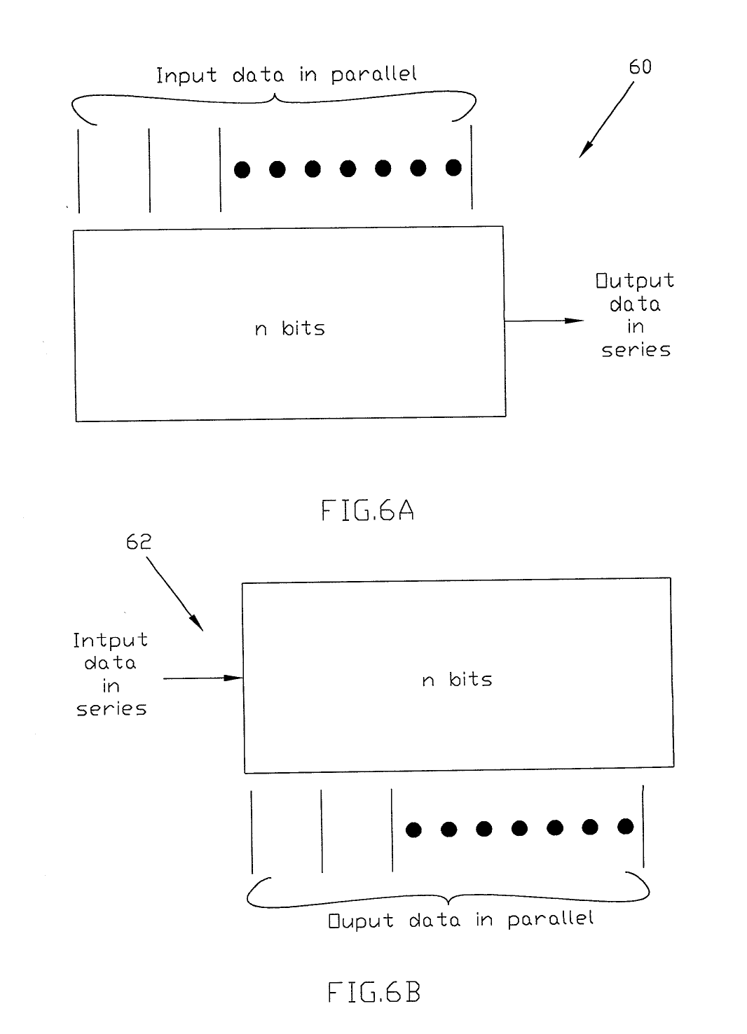

The parallel in-serial out interface 504 can be formed of a parallel in-serial out type register 60, as shown in FIG. 6A. The parallel in-serial out type register 60 includes a set of RS flip-flops connected in parallel. The output terminals of the RS flip-flops are connected together in series. All the data is simultaneously shifted to the parallel in-serial out type register 60. Then, the data per bit in the parallel in-serial out type register 60 is sequentially sent out upon a clock transition.

The serial in-parallel out interface 52 can be formed of a serial in-parallel out type register 62, as shown in FIG. 6B. The serial in-parallel out type register 62 includes a set of RS flip-flops connected together in series. Each RS flip-flop has an output terminal connected to a respective output pin.

The serial in-parallel out interface 52 then provides the set of digital signals in parallel to the stepping motor driver 54. As described in the background, the set of digital signals including +1 value and 0 value corresponds to a position state of the stepping motor 56. When the set of digital signals is sent to the stepping motor driver 54, the potential, i.e. positive potential or zero potential, that corresponds to each digital signal, is respectively applied to the corresponding terminal of the coils of the stepping motor 56 via an output pin 55. A potential across each of the coils is generated, and thereby the stepping motor 56 is driven to a predetermined step to the position state.

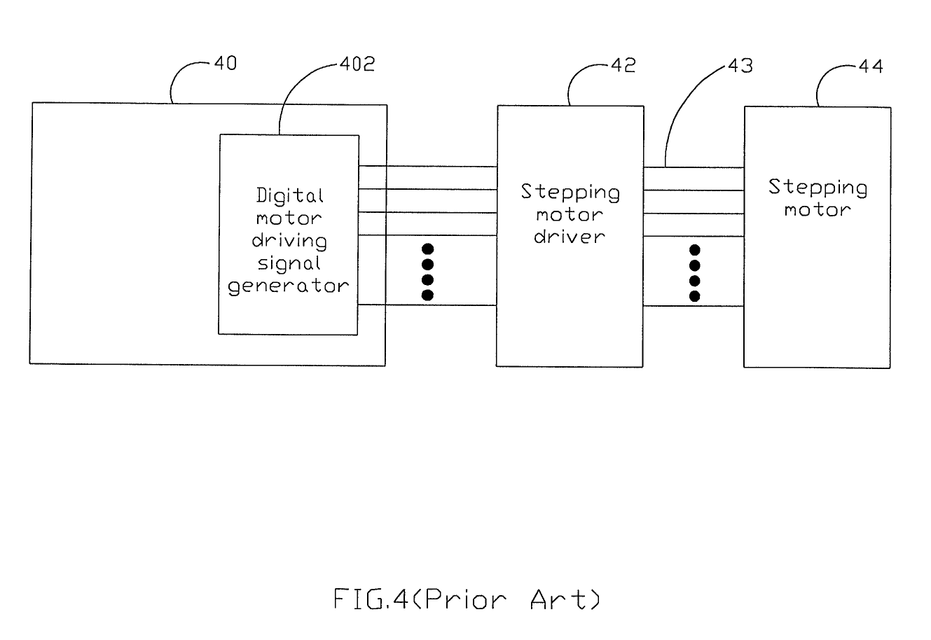

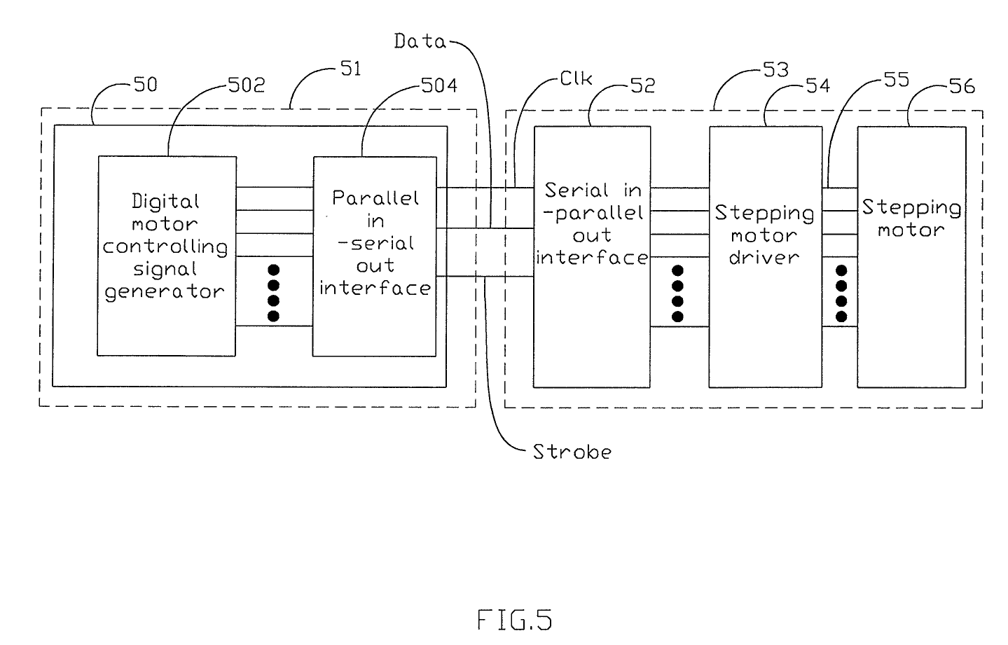

In accordance with the present invention, a parallel in-serial out interface 504 is established in control circuit 50. The control circuit 50 can send out a set of control signals in sequence via the parallel in-serial out interface 504 for the stepping motor 56. Therefore, the present invention does not need the control pin number for control circuit 50 to output control signals to the stepping motor driver 54 as the prior driving apparatus of FIG. 4. The control pin number used for the stepping motor control signals in the present invention is reduced and the volume of the control circuit has therefore shrunk. Furthermore, any additional device, such as automatic document feeder and upper transparence adapter, can be connected to the control circuit with smaller cables and connectors. The manufacturing cost of the controlling device is decreased. Moreover, the present invention can simultaneously drive a plurality of stepping motors utilizing a combination of the parallel in-serial out interface 504 and a serial in-parallel out interface 52 in case of not increasing the number of control pins for providing motor controlling signals.

The preferred embodiment is only used to illustrate the present invention; it is not intended to limit the scope thereof. Many modifications of the preferred embodiment can be made without departing from the spirit of the present invention.

What is claimed is:

1. A stepping motor control device, comprising:
a control circuit including a motor controlling signal generator and a parallel in-serial out interface, said motor controlling signal generator generating a set of control signals in parallel to said parallel in-serial out interface, thereby outputting the set of said control signals in sequence; and
a serial in-parallel out interface for receiving the set of said control signals in sequence and then outputting the set of said control signals in parallel to a stepping motor driver for driving a stepping motor to a predetermined step.

2. The control device as claimed in claim 1, wherein said control circuit comprises an application specific integrated circuit (ASIC).

3. The control device as claimed in claim 1, wherein the set of said control signals comprises digital signals of high logic level “1” and low logic level “0”.

4. A stepping motor control device, comprising:
a control circuit including a motor controlling signal generator and a parallel in-serial out interface, said motor controlling signal generator generating a set of control signals in parallel to said parallel in-serial out interface, thereby outputting the set of said control signals in sequence; and
a serial in-parallel out interface for receiving the set of said control signals in sequence and then outputting the set of said control signals in parallel to a stepping motor driver for simultaneously driving a plurality of stepping motors to a predetermined step.

5. The control device as claimed in claim 4, wherein said control circuit comprises an application specific integrated circuit (ASIC).

6. The control device as claimed in claim 4, wherein the set of said control signals comprises digital signals of high logic level “1” and low logic level “0”.

7. A device for controlling a stepping motor used in an image scanner, the stepping motor configured to move a scanning head of the image scanner, said device comprising:
a control circuit including a motor controlling signal generator and a parallel in-serial out interface, said motor controlling signal generator generating a set of control signals in parallel to said parallel in-serial out interface, thereby outputting the set of said control signals in sequence; and
a serial in-parallel out interface for receiving the set of said control signals in sequence and then outputting the set of said control signals in parallel to a stepping motor driver for driving said stepping motor to a predetermined step so as to move said scanning head.

8. The device as claimed in claim 7, wherein said control circuit comprises an application specific integrated circuit (ASIC).

9. The device as claimed in claim 7, wherein the set of said control signals comprises digital signals of high logic level “1” and low logic level “0”.

10. A stepping motor controlling method, comprising:
receiving a set of control signals in parallel;
transforming the set of control signals in parallel to a set of output signals in sequence; and
transforming the set of said output signals in sequence to the set of control signals in parallel and outputting them to a stepping motor driver for driving a stepping motor to a predetermined step.

11. The method as claimed in claim 10, wherein the set of said control signals comprises digital signals of high logic level “1” and low logic level “0”.
